(19) United States
(12) Patent Application Publication
(10) Pub. No.: US 2023/0009493 A1
(43) Pub. Date: Jan. 12, 2023

(54) METHOD OF PROCESSING POLYCRYSTALLINE DIAMOND MATERIAL

(71) Applicant: Element Six (UK) Limited, Didcot, Oxfordshire (GB)

(72) Inventors: David William Aldmington, Didcot (GB); Cristian Baleca, Didcot (GB); Carmen Elena Zvoriste-Walters, Didcot (GB)

(73) Assignee: Element Six (UK) Limited, Didcot, Oxfordshire (GB)

(21) Appl. No.: 17/784,936

(22) PCT Filed: Dec. 31, 2020
(86) PCT No.: PCT/EP2020/088079

§ 371 Date: Jun. 13, 2022

(30) Foreign Application Priority Data
Dec. 31, 2019 (GB) 1919481.0

(51) Int. Cl. B01J 3/06; C22C 29/02

(52) U.S. Cl. CPC B01J 3/06; C22C 29/02

(57) ABSTRACT

A method of processing a polycrystalline diamond (PCD) material having a non- diamond phase with a catalyst/solvent material includes leaching an amount of the catalyst/solvent from the PCD material by exposing at least a portion of the PCD material to a leaching mixture, the leaching mixture comprising hydrofluoric acid at a molar concentration of between 12 M to around 28 M, nitric acid at a molar concentration of between around 3 M to around 10 M, and water.

This disclosure relates to a method of processing a body of polycrystalline diamond (PCD) material, to a mixture for said processing and PCD constructions so processed.

### BACKGROUND

Cutter inserts for machining and other tools may comprise a layer of polycrystalline diamond (PCD) bonded to a cemented carbide substrate. PCD is an example of a superhard material, also called superabrasive material, which has a hardness value substantially greater than that of cemented tungsten carbide.

Components comprising PCD are used in a wide variety of tools for cutting, machining, drilling or degrading hard or abrasive materials such as rock, metal, ceramics, composites and wood-containing materials. PCD comprises a mass of substantially inter-grown diamond grains forming a skeletal mass, which defines interstices between the diamond grains. PCD material comprises at least about 80 volume % of diamond and may be made by subjecting an aggregated mass of diamond grains to an ultra-high pressure of greater than about 5 GPa, typically about 5.5 GPa, and temperature of at least about 1200° C., typically about 1440° C., in the presence of a sintering aid, also referred to as a catalyst material for diamond. Catalyst material for diamond is understood to be material that is capable of promoting direct inter- growth of diamond grains at a pressure and temperature condition at which diamond is thermodynamically more stable than graphite.

Examples of catalyst materials for diamond are cobalt, iron, nickel and certain alloys including alloys of any of these elements. PCD may be formed on a cobalt-cemented tungsten carbide substrate, which may provide a source of cobalt catalyst material for the PCD. During sintering of the body of PCD material, a constituent of the cemented-carbide substrate, such as cobalt from a cobalt-cemented tungsten carbide substrate, liquefies and sweeps from a region adjacent the volume of diamond particles into interstitial regions between the diamond particles. In this example, the cobalt acts as a catalyst to facilitate the formation of bonded diamond grains. Optionally, a metal- solvent catalyst may be mixed with diamond particles prior to subjecting the diamond particles and substrate to the HPHT process. The interstices within PCD material may at least partly be filled with the catalyst material. The intergrown diamond structure therefore comprises original diamond grains as well as a newly precipitated or re-grown diamond phase, which bridges the original grains. In the final sintered structure, catalyst/solvent material generally remains present within at least some of the interstices that exist between the sintered diamond grains.

Sintered PCD typically has sufficient wear resistance and hardness for use in aggressive wear, cutting and drilling applications however a well-known problem experienced with this type of PCD compact is that the presence of residual solvent/catalyst material in the microstructural interstices may have a detrimental effect on the performance of the compact at high temperatures as it is believed that the presence of the solvent/catalyst in the diamond table reduces the thermal stability of the diamond table at these elevated temperatures. For example, the difference in thermal expansion coefficient between the diamond grains and the solvent/catalyst is believed to lead to chipping or cracking in the PCD table of a cutting element during drilling or cutting operations. The chipping or cracking in the PCD table may degrade the mechanical properties of the cutting element or lead to failure of the cutting element. Additionally, at high temperatures, diamond grains may undergo a chemical breakdown or back-conversion with the solvent/catalyst. At extremely high temperatures, portions of diamond grains may transform to carbon monoxide, carbon dioxide, graphite, or combinations thereof, thereby degrading the mechanical properties of the PCD material.

A potential solution to these problems is to remove the catalyst/solvent or binder phase from the PCD material.

Chemical leaching is often used to remove metal-solvent catalysts, such as cobalt, from interstitial regions of a body of PCD material, such as from regions adjacent to the working surfaces of the PCD. It is typically extremely difficult and time consuming to remove effectively the bulk of a metallic catalyst/solvent from a PCD table, particularly from the thicker PCD tables required by current applications. In general, the current art is focused on achieving PCD of high diamond density and commensurately PCD that has an extremely fine distribution of metal catalyst/solvent pools. This fine network resists penetration by the leaching agents, such that residual catalyst/solvent often remains behind in the leached compact. Furthermore, achieving appreciable leaching depths can take so long as to be commercially unfeasible or require undesirable interventions such as extreme acid treatment or physical drilling of the PCD tables. There is therefore a need to overcome or substantially ameliorate the above-mentioned problems through a technique for treating or processing a body of PCD material.

### SUMMARY

Viewed from a first aspect there is provided a method of processing a polycrystalline diamond (PCD) material having a non-diamond phase comprising a diamond catalyst/solvent material, the method comprising leaching an amount of the catalyst/solvent from the PCD material by exposing at least a portion of the PCD material to a leaching mixture, the leaching mixture comprising:
between around 10 wt% to around 80 wt% hydrofluoric acid;
between around 10 wt% to around 80 wt% nitric acid; and
between around 10 wt% to around 40 wt% water.

Viewed from a second aspect there is provided a method of processing a polycrystalline diamond (PCD) material having a non-diamond phase comprising a catalyst/solvent material, the method comprising leaching an amount of the catalyst/solvent from the PCD material by exposing at least a portion of the PCD material to a leaching mixture, the leaching mixture comprising:
hydrofluoric acid at a molar concentration of between 12 M to around 28 M;
nitric acid at a molar concentration of between around 3 M to around 10 M; and
water.

Viewed from a third aspect there is provided a polycrystalline diamond construction treated according to the above-defined method to remove solvent/catalyst from at least a portion of interstitial spaces between interbonded diamond grains.

Viewed from a fourth aspect there is provided an acid leaching mixture for removing catalyst/solvent material from a polycrystalline diamond (PCD) material having a non-diamond phase comprising the catalyst/solvent material, the mixture comprising:
between around 10 wt% to around 80 wt% hydrofluoric acid;
between around 10 wt% to around 80 wt% nitric acid; and
between around 10 wt% to around 40 wt% water.

Viewed from a fifth aspect there is provided an acid leaching mixture for removing catalyst/solvent material from a polycrystalline diamond (PCD) material having a non-diamond phase comprising the catalyst/solvent material, the mixture comprising:
hydrofluoric acid at a molar concentration of between 12 M to around 28 M;
nitric acid at a molar concentration of between around 3 M to around 10 M; and
water.

### BRIEF DESCRIPTION OF THE DRAWINGS

Various versions will now be described in more detail, by way of example only, with reference to the accompanying figures in which:

FIG. 1 is a schematic perspective view of a PCD cutter insert for a cutting drill bit for boring into the earth;

FIG. 2 is a schematic cross section view of the PCD cutter insert of FIG. 1 together with a schematic expanded view showing the microstructure of the PCD material; and

FIG. 3 is a flow diagram of an exemplary method according to at least one example for processing a polycrystalline diamond material.

The same reference numbers refer to the same respective features in all drawings.

### DESCRIPTION

As used herein, a “superhard material” is a material having a Vickers hardness of at least about 28 GPa. Diamond and cubic boron nitride (cBN) material are examples of superhard materials.

As used herein, a “superhard construction” means a construction comprising a body of polycrystalline superhard material. In such a construction, a substrate may be attached thereto or alternatively the body of polycrystalline material may be free-standing and unbacked.

As used herein, polycrystalline diamond (PCD) is a type of polycrystalline superhard (PCS) material comprising a mass of diamond grains, a substantial portion of which are directly inter-bonded with each other and in which the content of diamond is at least about 80 volume percent of the material. In one example of PCD material, interstices between the diamond grains may be at least partly filled with a binder material comprising a catalyst for diamond. As used herein, “interstices” or “interstitial regions” are regions between the diamond grains of PCD material. In embodiments of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a superhard material is capable of promoting the growth or sintering of the superhard material.

The term “substrate” as used herein means any substrate over which the superhard material layer is formed. For example, a “substrate” as used herein may be a transition layer formed over another substrate.

As used herein, the term “integrally formed” regions or parts are produced contiguous with each other and are not separated by a different kind of material.

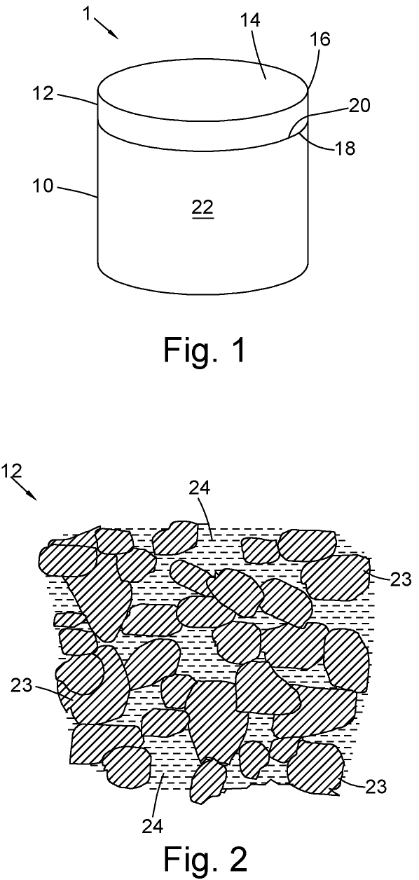

In an example as shown in FIG. 1, a cutting element 1 includes a substrate 10 with a layer of superhard material 12 formed on the substrate 10. The substrate 10 may be formed of a hard material such as cemented tungsten carbide. The superhard material 12 may be, for example, polycrystalline diamond (PCD), or a thermally stable product such as thermally stable PCD (TSP). The cutting element 1 may be mounted into a bit body such as a drag bit body (not shown) and may be suitable, for example, for use as a cutter insert for a drill bit for boring into the earth.

The exposed top surface of the superhard material opposite the substrate forms the cutting face 14, which is the surface which, along with its edge 16, performs the cutting in use.

At one end of the substrate 10 is an interface surface 18 that forms an interface with the superhard material layer 12 which is attached thereto at this interface surface. As shown in the embodiment of FIG. 1, the substrate 10 is generally cylindrical and has a peripheral surface 20 and a peripheral top edge 22.

As used herein, a PCD grade is a PCD material characterised in terms of the volume content and size of diamond grains, the volume content of interstitial regions between the diamond grains and composition of material that may be present within the interstitial regions. A grade of PCD material may be made by a process including providing an aggregate mass of diamond grains having a size distribution suitable for the grade, optionally introducing catalyst material or additive material into the aggregate mass, and subjecting the aggregated mass in the presence of a source of catalyst material for diamond to a pressure and temperature at which diamond is more thermodynamically stable than graphite and at which the catalyst material is molten. Under these conditions, molten catalyst material may infiltrate from the source into the aggregated mass and is likely to promote direct intergrowth between the diamond grains in a process of sintering, to form a PCD structure. The aggregate mass may comprise loose diamond grains or diamond grains held together by a binder material and said diamond grains may be natural or synthesised diamond grains.

Different PCD grades may have different microstructures and different mechanical properties, such as elastic (or Young’s) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

All of the PCD grades may comprise interstitial regions filled with material comprising cobalt metal, which is an example of catalyst material for diamond.

The PCD structure 12 may comprise one or more PCD grades.

FIG. 2 is a cross-section through a PCD material which may form the super hard layer 2 of FIG. 1 in an example cutter. During formation of a conventional polycrystalline diamond construction, the diamond grains 22 are directly interbonded to adjacent grains and the interstices 24 between the grains 22 of super hard material such as diamond grains in the case of PCD, may be at least partly filled with a non-super hard phase material. This non-super hard phase material, also known as a filler material, may comprise residual catalyst/binder material, for example cobalt, nickel or iron.

The term “molar concentration” as used herein, may refer to a concentration in units of mol/L at a temperature of approximately 25 deg. C. For example, a solution comprising solute A at a molar concentration of 1 M may comprise 1 mol of solute A per litre of solution.

In accordance with some examples of the method, a sintered body of PCD material is created having diamond to diamond bonding and having a second phase comprising solvent/catalyst dispersed through its microstructure together. The body of PCD material may be formed according to standard methods, using HpHT conditions to produce a sintered PCD table. The PCD tables to be leached by examples of the method typically, but not exclusively, have a thickness of about 1 .5 mm to about 4 mm.

It has been found that the removal of non-binder phase from within the PCD table, conventionally referred to as leaching, is desirable in various applications, for example because the residual presence of solvent/catalyst material in the microstructural interstices is believed to have a detrimental effect on the performance of PCD compacts at high temperatures as it is believed that the presence of the solvent/catalyst in the diamond table reduces the thermal stability of the diamond table at these elevated temperatures.

The reaction rate regarding leaching is considered to be dominated by the chemical rate initially as acid contacts a surface of the PCD table and later by the diffusion rate as the acid diffuses through the pores of the PCD table.

To improve the performance and heat resistance of a surface of the body of PCD material 12, at least a portion of the metal-solvent catalyst, such as cobalt, may be removed from the interstices 24 of at least a portion of the PCD material 12. Additionally, tungsten and/or tungsten carbide may be removed from at least a portion of the body of PCD material 12. Chemical leaching is used to remove the metal-solvent catalyst from the body of PCD material 12 either up to a desired depth from an external surface of the body of PCD material or from substantially all of the PCD material 12. Following leaching, the body of PCD material 12 may therefore comprise a first volume that is substantially free of a metal solvent/catalyst. However, small amounts of solvent/catalyst may remain within interstices that are inaccessible to the leaching process. Additionally, following leaching, the body of PCD material 12 may also comprise a volume that contains a metal solvent catalyst. In some examples, this further volume may be remote from one or more exposed surfaces of the body of PCD material 12.

The interstitial material which may include, for example, the metal solvent/catalyst and one or more additions in the form of carbide additions, may be leached from the interstices 24 in the body of PCD material 12 by exposing the PCD material to an example leaching mixture.

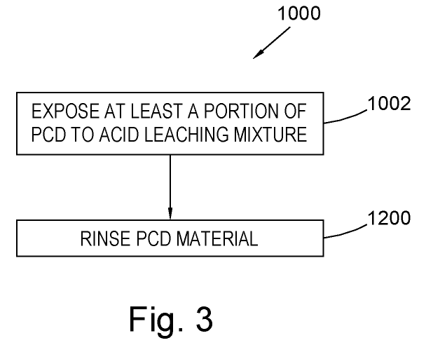

FIG. 3 is a flow diagram of an exemplary method 1000 for processing a PCD material. As illustrated in this figure, and as indicated at 1002, at least a portion of the PCD material to be processed is exposed to a leaching mixture which, according to examples, comprises hydrofluoric acid at a molar concentration of between 12 M to around 28 M, nitric acid at a molar concentration of between around 3 M to around 10 M, and water. In some examples, the leaching mixture comprises hydrofluoric acid at a molar concentration of between around 20 M to around 25 M; and nitric acid at a molar concentration of between around 3.2 M to around 7 M. In one example the leaching mixture comprises hydrofluoric acid at a molar concentration of around 20.1 M, nitric acid at a molar concentration of 3.2 M and water.

Expressed differently in terms of the wt%, the leaching mixture may comprise between around 10 wt% to around 80 wt% hydrofluoric acid, between around 10 wt% to around 80 wt% nitric acid, and between around 10 wt% to around 40 wt% water.

The water may be de-ionized water.

The body of PCD material may be exposed to such a leaching mixture in any suitable manner, including, for example, by immersing at least a portion of the body of PCD material 12 in the leaching mixture for a period of time.

According to some examples, the body 12 of PCD material may be exposed to the leaching mixture at an elevated temperature, for example to a temperature at which the acid leaching mixture is boiling or, for example temperatures of between around 40 to around 70° C. Exposing the body of PCD material to an elevated temperature during leaching may increase the depth to which the PCD material may be leached and reduce the leaching time necessary to reach the desired leach depth. If only a portion of the body of PCD material is to be leached, the body, and if it is still attached to the substrate, the substrate may be at least partially surrounded by a protective layer to prevent the leaching solution from chemically damaging certain portions of the body of PCD material and/or the substrate attached thereto during leaching. Such a configuration may provide selective leaching of the body of PCD material, which may be beneficial. Following leaching, the protective layer or mask may be removed.

Also, after exposure to the acid leaching mixture for the desired time, the body of PCD material may be rinsed to remove residual acid leaching mixture therefrom, as illustrated in step 1200 in FIG. 3.

Additionally, in some examples, at least a portion of the body of PCD material and the leaching solution may be exposed to at least one of an electric current, microwave radiation, and/or ultrasonic energy to increase the rate at which the body of PCD material is leached.

Some versions are described in more detail with reference to the following examples which are not intended to be limiting. The following examples provide further detail in connection with the examples described above.

### Example 1

Cutting elements, each comprising a PCD table attached to a tungsten carbide substrate, were formed by HPHT sintering of diamond particles in the presence of cobalt. The sintered-polycrystalline-diamond tables included cobalt within the interstitial regions between the bonded diamond grains. The PCD table was leached using a solution comprising 3.2 M nitric acid, 20.1 M hydrofluoric acid and water.

The PCD table was leached for 100 hours at a temperature of around 7° C.

At this time the leached depth of the PCD table was determined for various portions of the PCD table, through x-ray analysis. It was found that an average leach depth of 470 microns had been achieved after 100 hours. This is in contrast to an equivalent cutting element formed of an identical PCD table attached to a tungsten carbide substrate leached according to a conventional leaching mixture which was found to have an average leach depth of 345 microns after 100 hours. The same cutters were replaced in the leaching solution for a further 400 hours after which the leach depth for the cutting element subjected to the example leaching mixture was determined to have an average depth of 1178 microns compared to the cutter leached with a conventional acid mixture which had an average leach depth of 885 microns.

When compared with the leach depths achievable using conventional leaching solutions, it has been determined that the embodiments including the above leaching mixtures may enable a greater leaching efficiency to be achieved with greater leach depths being achievable in a shorter period of time and, in some examples, an improvement of around 30 % in leach rate may be achievable.

The preceding description has been provided to enable others skilled the art to best utilize various aspects described by way of example herein. This description is not intended to be exhaustive or to be limited to any precise form disclosed. Many modifications and variations are possible. In particular, whilst some embodiments of the method have been described as being effective in leaching PCD containing Co, the method may be equally applicable to the effective leaching of PCD with other additives or interstitial material such as those in the form of other metal carbides including one or more of a carbide of tungsten, titanium, niobium, tantalum, zirconium, molybdenum, vanadium or chromium.

1. A method of processing a polycrystalline diamond (PCD) material having a non-diamond phase comprising a catalyst/solvent material, the method comprising leaching an amount of the catalyst/solvent from the PCD material by exposing at least a portion of the PCD material to a leaching mixture, the leaching mixture comprising:
hydrofluoric acid at a molar concentration of between 12 M to around 28 M;
nitric acid at a molar concentration of between around 3 M to around 10 M; and water.

2. A method according to claim 1, wherein the leaching mixture comprises hydrofluoric acid at a molar concentration of between around 20 M to around 25 M; and nitric acid at a molar concentration of between around 3.2 M to around 7 M.

3. The method of claim 1 wherein the water comprises de-ionized water.

4. The method of claim 1, further comprising heating the leaching mixture to a temperature equal to or greater than the boiling temperature of the leaching mixture during the step of exposing the PCD material to the leaching mixture.

5. The method of claim 1, further comprising heating the leaching mixture to a temperature of between around 40° C. to around 100° C.

6. The method of claim 1, wherein the metal solvent/catalyst comprises at least one of cobalt, nickel and/or iron.

7. The method according to claim 1, wherein the PCD table has a thickness of from about 1.5 mm to about 4.0 mm.

8. The method according to claim 1, wherein the step of leaching comprises leaching one or more of a carbide of tungsten, titanium, niobium, tantalum, zirconium, molybdenum, chromium, or vanadium from the PCD material.

9. The method of processing a polycrystalline diamond (PCD) material of claim 1 wherein:
the hydrofluoric acid content in the leaching mixture comprises between around 10 wt% to around 80 wt%;
the nitric acid content in the leaching mixture comprises between around 10 wt% to around 80 wt%; and
the water content in the leaching mixture comprises between around 10 wt% to around 40 wt%.

10. The method of claim 1, further comprising rinsing the PCD material after exposing at least a portion of the material to the leaching mixture to remove residual acid leaching mixture from the PCD material after removing residual catalyst/binder from at least a portion of the PCD material.

11. A polycrystalline diamond construction treated according to claim 1 to remove solvent/catalyst from at least a portion of interstitial spaces between interbonded diamond grains.

12. An acid leaching mixture for removing catalyst/solvent material from a polycrystalline diamond (PCD) material having a non-diamond phase comprising the catalyst/solvent material, the mixture comprising:
hydrofluoric acid at a molar concentration of between 12 M to around 28 M;
nitric acid at a molar concentration of between around 3 M to around 10 M; and water.

13. The acid leaching mixture of claim 12, wherein the leaching mixture comprises hydrofluoric acid at a molar concentration of between around 20 M to around 25 M; and nitric acid at a molar concentration of between around 3.2 M to around 7 M.

14. The acid leaching mixture of claim 12, wherein the water is de-ionized water.

15. An acid leaching mixture for removing catalyst/solvent material from a polycrystalline diamond (PCD) material having a non-diamond phase comprising the catalyst/solvent material, the mixture comprising:
between around 10 wt% to around 80 wt% hydrofluoric acid;
between around 10 wt% to around 80 wt% nitric acid; and
between around 10 wt% to around 40 wt% water.
